(19) United States
(12) Patent Application Publication
(10) Pub. No.: US 2026/0063547 A1
(43) Pub. Date: Mar. 5, 2026

(54) NOISE SUPPRESSION USING SIGNAL STRENGTH RATIO METRIC MODULATED LIGHT

(71) Applicant: Microchip Technology Incorporated, Chandler, AZ (US)

(72) Inventors: Arthur B. Eck, Gilbert, AZ (US); Patrick McFarland, Gilbert, AZ (US); Jonathan Corbett, Havertown, PA (US); Robert Perkel, Chandler, AZ (US)

(73) Assignee: Microchip Technology Incorporated, Chandler, AZ (US)

(21) Appl. No.: 18/933,683

(22) Filed: Oct. 31, 2024

Related U.S. Application Data
(60) Provisional application No. 63/690,673, filed on Sep. 4, 2024.

(51) Int. Cl. G01N 21/53; G01N 21/47

(52) U.S. Cl. CPC G01N 21/53; G01N 2021/4733; G01N 2201/1215

(57) ABSTRACT

A system and method for noise suppression using signal strength ratio metric modulated light are disclosed. The system may include a light source, a light sensor, and a control circuit. The control circuit may be to generate a signal strength ratio metric modulated signal at a modulation depth. The control circuit may also be to send the signal strength ratio metric modulated signal to the light source to cause the light source to emit a signal strength ratio metric modulated light beam. The control circuit may additionally be to receive a reflected light signal from the light sensor. The reflected light signal may include a signal indicative of a reflection of the signal strength ratio metric modulated light beam and a signal indicative of a noise light.

### PRIORITY

This application claims priority to U.S. Provisional Patent Application No. 63/690,673 filed Sep. 4, 2024, the contents of which are hereby incorporated in their entirety.

### TECHNICAL FIELD

The present disclosure relates to photoelectric smoke detectors and, in particular, to noise suppression using signal strength ratio metric modulated light.

### BACKGROUND

A photoelectric smoke detector uses non-polarized light to detect smoke particles. Photoelectric smoke detectors may include a chamber or may be chamberless (also referred to as “open room detectors”). A light source in the smoke detector emits a small light beam. The light beam may be emitted at a fixed level or in adjustable step levels. When smoke particles are present, the smoke particles scatter the light beam. A light sensor in the smoke detector detects the scattered light to allow an alarm to be triggered indicating the presence of smoke particles. The light source and light sensor may be positioned off angle such that when smoke is present, the smoke reflects the light and causes the receiver to receive the reflected light.

To calibrate the smoke detector, when the light source is not emitting a beam of light, a “dark” measurement may be taken to identify the conditions in the chamber or open room. After the dark measurement, the light source may emit a light pulse of a few milliseconds in duration to measure whether light reflects off smoke present in the chamber or room. Extraneous ambient light (e.g., from the sun or lighting in a room) may be difficult to distinguish from the transmitted light pulse, especially if the photoelectric smoke detector is an open room detector.

Underwriters Laboratories (UL) establishes standards for product safety. UL standards for smoke detectors establish requirements for, for example, sensitivity and reliability. UL standards require that smoke detectors have less sensitivity to cooking fires and more sensitivity to smoldering fires. These standards have resulted in the tripping point of a smoke detector moving closer to the noise floor, causing noise from extraneous light to be a greater problem.

### SUMMARY OF THE INVENTION

Aspects provide systems and methods for noise suppression using signal strength ratio metric modulated light. Examples of the present disclosure may include an apparatus. The apparatus may include a light source interface communicatively coupled to a light source in a photoelectric smoke detector. The apparatus may also include a light sensor interface communicatively coupled to a light sensor in the photoelectric smoke detector. The apparatus may further include a control circuit communicatively coupled to the light source interface and the light sensor interface. The control circuit may be to generate a signal strength ratio metric modulated signal at a modulation depth. The control circuit may also be to send the signal strength ratio metric modulated signal to the light source interface to cause the light source to emit a signal strength ratio metric modulated light beam. The control circuit may be additionally to receive a reflected light signal from the light sensor via the light sensor interface. The reflected light signal may include a signal indicative of a reflection of the signal strength ratio metric modulated light beam and a signal indicative of a noise light.

In combination with any of the above examples, the control circuit may be to demodulate the reflected light signal to create a demodulated reflected light signal. The control circuit may also be to determine a strength of the demodulated reflected light signal. The control circuit may additionally be to trigger an alarm when the strength of the demodulated reflected light signal exceeds a threshold.

In combination with any of the above examples, the control circuit may be to demodulate the reflected light signal to create a demodulated reflected light signal. The control circuit may also be to determine a strength and a modulation depth of the demodulated reflected light signal. The control circuit may be additionally to determine a strength of the reflected light signal. The control circuit may be to compare the modulation depth of the demodulated reflected light signal to the modulation depth of the signal strength ratio metric modulated signal to determine an interference noise. The control circuit may also be to trigger a retest when the interference noise exceeds a threshold.

In combination with any of the above examples, the control circuit may be to determine a modulation depth of the signal strength ratio metric modulated signal.

In combination with any of the above examples, the control circuit may be to determine, using spread spectrum modulation, a set of modulation frequencies of the signal strength ratio metric modulated signal.

In combination with any of the above examples, the control circuit may be to demodulate the reflected light signal to create a demodulated reflected light signal. The control circuit may also be to identify a noise signal in the demodulated reflected light signal. The control circuit may be additionally to subtract the noise signal from the demodulated reflected light signal to isolate a portion of the demodulated reflected light signal corresponding to the reflection of the signal strength ratio metric modulated light beam.

In combination with any of the above examples, the control circuit may be to demodulate the reflected light signal to create a demodulated reflected light signal. The control circuit may also be to integrate the demodulated reflected light signal to increase a signal-to-noise ratio of the demodulated reflected light signal.

Alone or in combination with any of the above examples, examples of the present disclosure may include a system. The system may include a light source, a light sensor, and a control circuit. The control circuit may be to generate a signal strength ratio metric modulated signal at a modulation depth. The control circuit may also be to send the signal strength ratio metric modulated signal to the light source to cause the light source to emit a signal strength ratio metric modulated light beam. The control circuit may additionally be to receive a reflected light signal from the light sensor. The reflected light signal may include a signal indicative of a reflection of the signal strength ratio metric modulated light beam and a signal indicative of a noise light.

In combination with any of the above examples, the control circuit may be to demodulate the reflected light signal to create a demodulated reflected light signal. The control circuit may also be to determine a strength of the demodulated reflected light signal. The control circuit may be additionally to trigger an alarm when the strength of the demodulated reflected light signal exceeds a threshold.

In combination with any of the above examples, the control circuit may be to demodulate the reflected light signal to create a demodulated reflected light signal. The control circuit may also be to determine a strength and a modulation depth of the demodulated reflected light signal. The control circuit may be additionally to determine a strength of the reflected light signal. The control circuit may be to compare the modulation depth of the demodulated reflected light signal to the modulation depth of the signal strength ratio metric modulated signal to determine an interference noise. The control circuit may be additionally to trigger a retest when the interference noise exceeds a threshold.

In combination with any of the above examples, the control circuit may be to determine a modulation depth of the signal strength ratio metric modulated signal.

In combination with any of the above examples, the control circuit may be to determine, using spread spectrum modulation, a set of modulation frequencies of the signal strength ratio metric modulated signal.

In combination with any of the above examples, the control circuit may be to demodulate the reflected light signal to create a demodulated reflected light signal. The control circuit may also be to identify a noise signal in the demodulated reflected light signal. The control circuit may be additionally to subtract the noise signal from the demodulated reflected light signal to isolate a portion of the demodulated reflected light signal corresponding to the reflection of the signal strength ratio metric modulated light beam.

In combination with any of the above examples, the control circuit may be to demodulate the reflected light signal to create a demodulated reflected light signal. The control circuit may also be to integrate the demodulated reflected light signal to increase a signal-to-noise ratio of the demodulated reflected light signal.

Alone or in combination with any of the above examples, examples of the present disclosure may include a method. The method may include generating a signal strength ratio metric modulated signal at a modulation depth to cause a light source in a photoelectric smoke detector to emit a signal strength ratio metric modulated light beam. The method may also include receiving a reflected light signal from a light sensor in the photoelectric smoke detector. The reflected light signal may include a signal indicative of a reflection of the signal strength ratio metric modulated light beam and a signal indicative of a noise light.

In combination with any of the above examples, the method may include demodulating the reflected light signal to create a demodulated reflected light signal. The method may also include determining a strength of the demodulated reflected light signal. The method may additionally include triggering an alarm when the strength of the demodulated reflected light signal exceeds a threshold.

In combination with any of the above examples, the method may include demodulating the reflected light signal to create a demodulated reflected light signal. The method may also include determining a strength and a modulation depth of the demodulated reflected light signal. The method may additionally include determining a strength of the reflected light signal. The method may include comparing the modulation depth of the demodulated reflected light signal to the modulation depth of the signal strength ratio metric modulated signal to determine an interference noise. The method may also include triggering a retest when the interference noise exceeds a threshold.

In combination with any of the above examples, the method may include determining, using spread spectrum modulation, a set of modulation frequencies of the signal strength ratio metric modulated signal.

In combination with any of the above examples, the method may include demodulating the reflected light signal to create a demodulated reflected light signal. The method may also include identifying a noise signal in the demodulated reflected light signal. The method may additionally include subtracting the noise signal from the demodulated reflected light signal to isolate a portion of the demodulated reflected light signal corresponding to the reflection of the signal strength ratio metric modulated light beam.

In combination with any of the above examples, the method may include demodulating the reflected light signal to create a demodulated reflected light signal. The method may also include integrating the demodulated reflected light signal to increase a signal-to-noise ratio of the demodulated reflected light signal.

### BRIEF DESCRIPTION OF THE DRAWINGS

The figures illustrate examples of systems and methods for noise suppression using signal strength ratio metric modulated light in a photoelectric smoke detector.

FIG. 1 illustrates a diagram of an example system for noise suppression using signal strength ratio metric modulated light in a photoelectric smoke detector, according to examples of the present disclosure;

FIG. 2 illustrates a diagram of an example system for noise suppression using signal strength ratio metric modulated light in a photoelectric smoke detector, according to examples of the present disclosure;

FIG. 3 illustrates a block diagram of an apparatus for noise suppression using signal strength ratio metric modulated light in a photoelectric smoke detector, according to examples of the present disclosure;

FIG. 4 illustrates a block diagram of a system for noise suppression using signal strength ratio metric modulated light in a photoelectric smoke detector, according to examples of the present disclosure;

FIG. 5 illustrates a method performed for noise suppression using signal strength ratio metric modulated light in a photoelectric smoke detector, according to examples of the present disclosure; and

FIGS. 6A and 6B illustrate a method performed for noise suppression using signal strength ratio metric modulated light in a photoelectric smoke detector, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, a system and method for noise suppression using signal strength ratio metric modulated light in a photoelectric smoke detector are provided. The disclosed system and method may use signal strength ratio metric modulated light to reduce the noise in a reflected light signal. By using signal strength ratio metric modulated light, noise may be reduced so that more stringent certifications may be met with less yield loss. Additionally, noise reduction may allow for examples where the photoelectric smoke detector is used in an open room, removing the cost of a chamber. Chamberless photoelectric smoke detectors may eliminate the collection of dust in the chamber that occurs over time, restricting air flow through the chamber and reducing the effectiveness of smoke detection by the detector. Additionally, by reducing noise, the brightness of the light may be reduced to save energy and increase battery life.

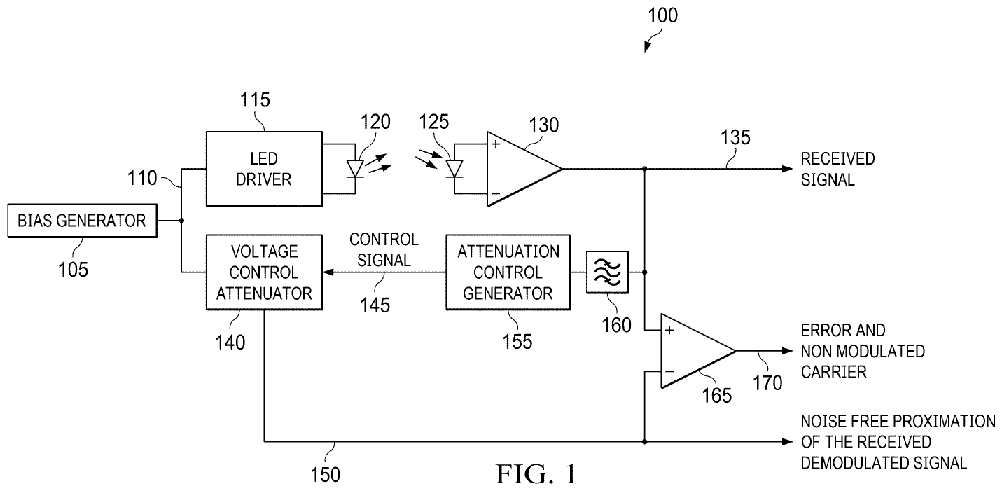

FIG. 1 illustrates an example system for noise suppression using signal strength ratio metric modulated light in a photoelectric smoke detector, according to examples of the present disclosure. System 100 may be used to emit a signal strength ratio metric modulated light beam and receive a reflected light beam when the signal strength ratio metric modulated light beam is reflected off a smoke particle. The signal indicative of the reflected light beam may be processed to suppress noise in the reflected light signal.

System 100 may include bias generator 105. Bias generator 105 may produce a signal strength ratio metric modulating signal 110 such that LED driver 115 causes light source 120 to emit signal strength ratio metric modulated signal. The signal strength ratio metric modulated signal may be amplitude modulated or pulse width modulated. The frequency of the modulating bias may be tonal, hopping code, spread spectrum. Bias generator 105 may be communicatively coupled to LED driver 115 such that signal strength ratio metric modulating signal 110 may be provided to LED driver 115 to cause LED driver 115 to drive signal strength ratio metric modulating signal 110 to light source 120 to cause light source 120 to emit a signal strength ratio metric modulated light beam.

When smoke particles are present in the vicinity of the photoelectric smoke detector of which system 100 is a part, the signal strength ratio metric modulated light beam may be reflected off the smoke particles. The reflected light beam may be received by light sensor 125 and converted by operational amplifier 130 to reflected light signal 135. Reflected light signal 135 may be indicative of the reflected light beam. Reflected light signal 135 may also include a noise signal caused by extraneous light received by light sensor 125 that is not reflected from the signal strength ratio metric modulated light beam. For example, in examples where the photoelectric smoke detector includes a chamber surrounding light source 120 and light sensor 125, the chamber may include baffles along the outer perimeter of the chamber. The baffles may allow smoke to enter the chamber and may reduce the amount of ambient light entering the chamber. When ambient light enters the chamber (referred to as “baffle reflection leakage light”), the ambient light may be detected by light sensor 125, causing the photoelectric smoke detector to incorrectly identify the presence of smoke particles. At least a portion of the noise signal may be indicative of the baffle reflection leakage light. The noise signal may also be caused by line and switching noise and reflections in the chamber.

Reflected light signal 135 may also be communicated to bandpass filter 160 which may be used to remove out-of-band modulating noise and pass the filtered signal to attenuation control signal generator 155. Therefore, attenuation control signal generator 155 may pass control signal 145 that is noise free and indicative of reflected light signal 135.

Signal strength ratio metric modulating signal 110 may also be communicated to voltage control attenuator 140. Attenuation control signal generator 155 may be commutatively coupled to voltage control attenuator 140 and may output control signal 145 to voltage control attenuator 140 so that signal strength ratio metric modulating signal may be communicatively coupled at a level of the received signal. Voltage control attenuator may demodulate the received signal and may create attenuated signal strength ratio metric modulating signal 150. Attenuated signal strength ratio metric modulating signal 150 may be indicative of reflected light signal 135 if reflected light signal 135 did not include a noise signal.

Reflected light signal 135 and attenuated signal strength ratio metric modulated signal 150 may be inputs to operational amplifier 165. Operational amplifier 165 may subtract attenuated signal strength ratio metric modulated signal 150 from reflected light signal 135 and output noise signal 170. Noise signal 170 may be indicative of the noise in the received signal. Noise signal 170 may be used to analyze nature of noise and noise level.

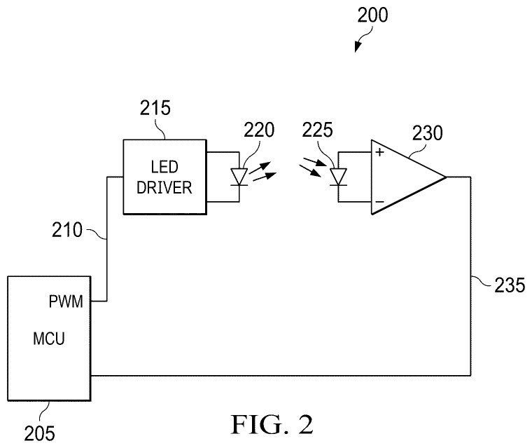

FIG. 2 illustrates a diagram of an example system for noise suppression using signal strength ratio metric modulated light in a photoelectric smoke detector, according to examples of the present disclosure. System 200 may be used to emit a signal strength ratio metric modulated light beam and receive a reflected light beam when the signal strength ratio metric modulated light beam is reflected off a smoke particle. The signal indicative of the reflected light beam may be processed to suppress noise in the signal.

System 200 may perform similar functions as system 100 shown in FIG. 1, but may use software executing on microcontroller 205 to perform the functions of bias generator 105, voltage control attenuator 140, attenuation control signal generator 155, bandpass filter 160, and operational amplifier 165. While described as a microcontroller, microcontroller 205 may be a microcontroller, a digital signal processor (DSP), an application specific integrated circuit (ASIC), a field-programmable gate array (FPGA), a state machine, or any other suitable device. Specifically, microcontroller 205 may produce signal strength ratio metric modulated signal 210. Signal strength ratio metric modulated signal 210 may be an amplitude modulated signal or a pulse width modulated signal. Microcontroller 205 may be communicatively coupled to LED driver 215 such that signal strength ratio metric modulated signal 210 may be provided to LED driver 215 to cause LED driver 215 to drive signal strength ratio metric modulated signal 210 to light source 220 to cause light source 220 to emit a signal strength ratio metric modulated light beam.

When smoke particles are present in the vicinity of the photoelectric smoke detector of which system 200 is a part, the signal strength ratio metric modulated light beam may be reflected off the smoke particles. The reflected light beam may be received by light sensor 225 and converted by operational amplifier 230 to reflected light signal 235. Reflected light signal 235 may be indicative of the reflected light beam. Reflected light signal 235 may also include a noise signal caused by extraneous light received by light sensor 225 that is not reflected from the signal strength ratio metric modulated light beam. The noise signal may also be caused by line noise, line and switching noise, and reflections in the chamber.

Microcontroller 205 may demodulate reflected light signal 235 and determine a strength of the demodulated reflected light signal. Based on the strength of the demodulated reflected light signal, microcontroller 205 may trigger a retest if strength of the demodulated reflected light signal exceeds a threshold. For example, the threshold may be set by local regulations and be based on the percent obscuration of the noise in the reflected light signal.

Microcontroller 205 may also determine a modulation depth of the demodulated reflected light signal and compare the modulation depth of the demodulated reflected light signal to the modulated depth of signal strength ratio metric modulated signal 210. Based on the comparison, microcontroller 205 may trigger a retest if difference in modulation depth exceeds a threshold. For example, if the noise is too high, the modulation depth difference may exceed a threshold at which the percent obscuration minimum as required by local regulations cannot be measured.

Microcontroller 205 may further determine a modulation frequency of signal strength ratio metric modulated signal 210. Microcontroller 205 may determine the modulation frequency using any suitable technique, including, but not limited to, spread spectrum modulation.

Microcontroller 205 may also identify the noise signal in the demodulated reflected light signal and subtract the noise signal from the demodulated reflected light signal. After the noise signal is subtracted from the demodulated reflected light signal, the remaining portion of the demodulated reflected light signal may correspond to a noise suppressed reflection of the signal strength ratio metric modulated light beam.

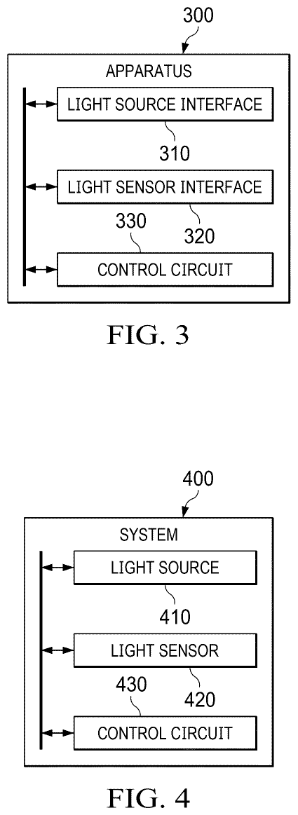

FIG. 3 illustrates a block diagram of an apparatus for noise suppression using signal strength ratio metric modulated light in a photoelectric smoke detector, according to examples of the present disclosure. Apparatus 300 may include light source interface 310 and light sensor interface 320 communicatively coupled to control circuit 330.

Light source interface 310 may allow control circuit 330 to send and receive signals from a light source, such as light source 120 or light source 220 shown in FIGS. 1 and 2, respectively. For example, control circuit 330 may send a signal to the light source via light source interface 310 to cause the light source to emit a signal strength ratio metric modulated light beam.

Light sensor interface 320 may allow control circuit 330 to send and receive signals from a light sensor, such as light sensor 125 or light sensor 225 shown in FIGS. 1 and 2, respectively. For example, control circuit 330 may receive a reflected light signal from the light sensor via light sensor interface 320.

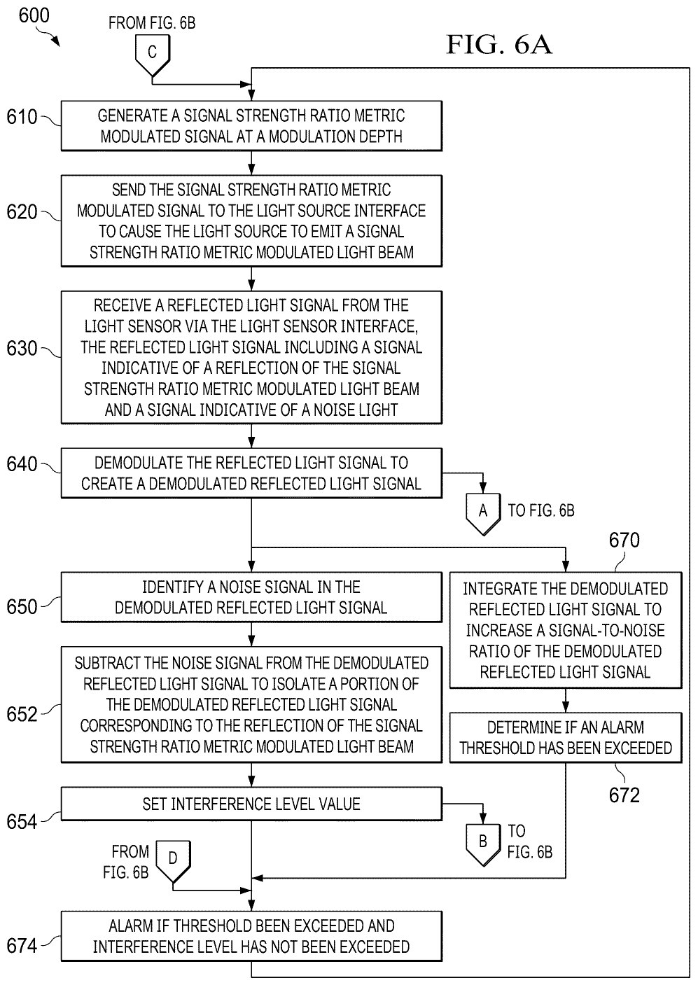

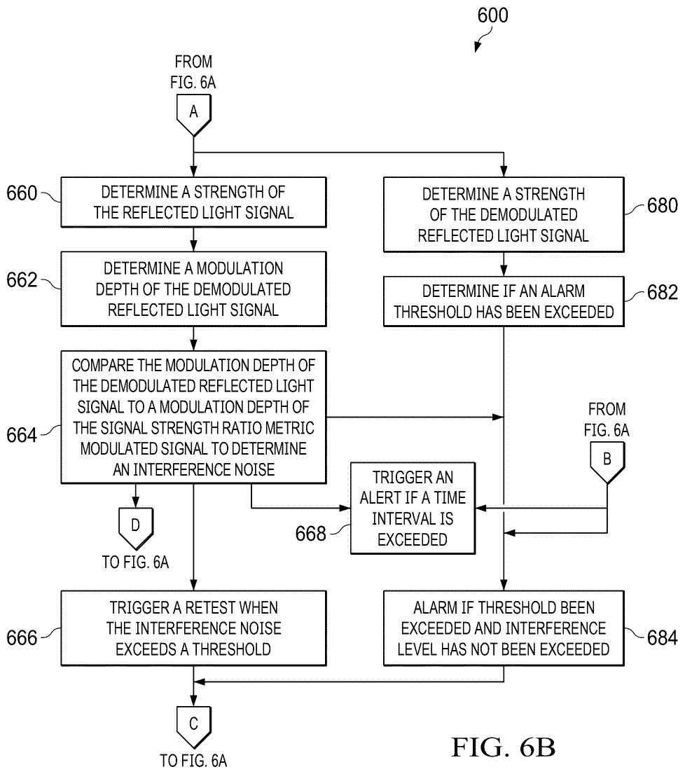

Control circuit 330 may include a central processing unit (CPU), a general purpose processor, a specific purpose processor, a microcontroller, a programmable logic controller (PLC), a DSP, an ASIC, an FPGA, or other programmable logic device, discrete gate or transistor logic, discrete hardware components, other programmable device, or any combination thereof designed to perform the functions disclosed herein, in combination with a processor, or any other system operable to implement a method for noise suppression using signal strength ratio metric modulated light in a photoelectric smoke detector. For example, control circuit 330 may include one or more of the components of system 100, such as bias generator 105, voltage control attenuator 140, attenuation control signal generator 155, bandpass filter 160, and operational amplifier 165, shown in FIG. 1 or may be microcontroller 205 shown in FIG. 2. The operations of control circuit 330 are described in further detail with respect to FIGS. 5 and 6.

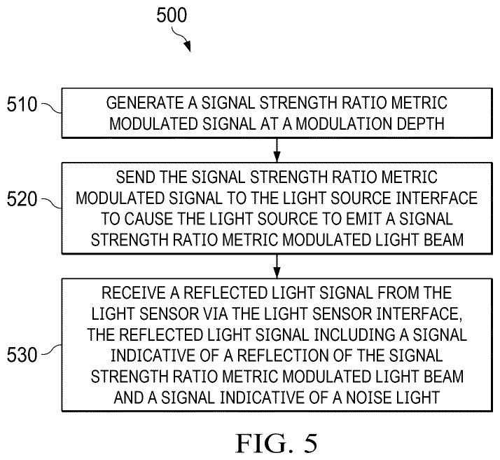

FIG. 4 illustrates a block diagram of a system for noise suppression using signal strength ratio metric modulated light in a photoelectric smoke detector, according to examples of the present disclosure. System 400 may include light source 410 and light sensor 420 communicatively coupled to control circuit 430.

Light source 410 may emit a signal strength ratio metric modulated light beam. Light source 410 may be similar to light source 120 or light source 220 shown in FIGS. 1 and 2, respectively. Light source 410 may emit the signal strength ratio metric modulated light beam in response to signals received directly or indirectly from control circuit 430.

Light sensor 420 may receive a reflected light signal and communicate the reflected light signal to control circuit 430. Light sensor 420 may be similar to light sensor 125 or light sensor 225 shown in FIGS. 1 and 2, respectively.

Control circuit 430 may be similar to control circuit 330 shown in FIG. 3 and may include a CPU, a general purpose processor, a specific purpose processor, a microcontroller, a PLC, a DSP, an ASIC, an FPGA, or other programmable logic device, discrete gate or transistor logic, discrete hardware components, other programmable device, or any combination thereof designed to perform the functions disclosed herein, in combination with a processor, or any other system operable to implement a method for noise suppression using signal strength ratio metric modulated light in a photoelectric smoke detector. For example, control circuit 430 may include one or more of the components of system 100, such as bias generator 105, voltage control attenuator 140, attenuation control signal generator 155, bandpass filter 160, and operational amplifier 165, shown in FIG. 1 or may be microcontroller 205 shown in FIG. 2. The operations of control circuit 430 are described in further detail with respect to FIGS. 5 and 6.

FIG. 5 illustrates a method performed for noise suppression using signal strength ratio metric modulated light in a photoelectric smoke detector, according to examples of the present disclosure. Method 500 may be implemented using a control circuit such as a CPU, a general purpose processor, a specific purpose processor, a microcontroller, a PLC, a DSP, an ASIC, an FPGA or other programmable logic device, discrete gate or transistor logic, discrete hardware components, other programmable device, or any combination thereof designed to perform the functions disclosed herein, in combination with a processor, or any other system operable to implement method 500. For example, method 500 may be implemented by control circuit 330 or control circuit 430 shown in FIGS. 3 and 4, respectively. Although examples have been described above, other variations and examples may be made from this disclosure without departing from the spirit and scope of these disclosed examples.

Method 500 may begin at block 510 where the control circuit may generate a signal strength ratio metric modulated signal at a modulation depth. The signal strength ratio metric modulated signal may be an amplitude modulated signal or a pulse width modulated signal. The signal strength ratio metric modulated signal may be generated using any suitable modulation technique including, but not limited to, carrier spread spectrum, spread spectrum modulation, or any combination thereof. Additionally, the control circuit may determine a modulation depth of the signal strength ratio metric modulated signal and generate the signal strength ratio metric modulated signal at that modulation depth. The signal strength ratio modulated signal may be 100% modulated so as to increase the demodulated signal strength.

At block 520, the control circuit may send the signal strength ratio metric modulated signal to the light source interface to cause the light source to emit a signal strength ratio metric modulated light beam. The light source may emit the signal strength ratio metric modulated light beam in any suitable type of photoelectric smoke detector including, but not limited to, a chambered or chamberless photoelectric smoke detector.

At block 530, the control circuit may receive a reflected light signal from the light sensor via the light sensor interface. The reflected light signal may include a signal indicative of a reflection of the signal strength ratio metric light beam and a signal indicative of a noise light. The noise light may be caused by baffle reflection leakage light, line noise, or any combination thereof.

Although FIG. 5 discloses a particular number of operations related to method 500, method 500 may be executed with greater or fewer operations than those depicted in FIG. 5. In addition, although FIG. 5 discloses a certain order of operations to be taken with respect to method 500, the operations comprising method 500 may be completed in any suitable order.

FIGS. 6A and 6B illustrate a method performed for noise suppression using signal strength ratio metric modulated light in a photoelectric smoke detector, according to examples of the present disclosure. Method 600 may be implemented using a control circuit such as a CPU, a general purpose processor, a specific purpose processor, a microcontroller, a PLC, a DSP, an ASIC, an FPGA or other programmable logic device, discrete gate or transistor logic, discrete hardware components, other programmable device, or any combination thereof designed to perform the functions disclosed herein, in combination with a processor, or any other system operable to implement method 600. For example, method 600 may be implemented by control circuit 330 or control circuit 430 shown in FIGS. 3 and 4, respectively. Although examples have been described above, other variations and examples may be made from this disclosure without departing from the spirit and scope of these disclosed examples.

Method 600 may begin at block 610 where the control circuit may generate a signal strength ratio metric modulated signal at a modulation depth. The signal strength ratio metric modulated signal may be an amplitude modulated signal or a pulse width modulated signal. The signal strength ratio metric modulated signal may be generated using any suitable modulation technique including, but not limited to, carrier spread spectrum, spread spectrum modulation, or any combination thereof. Additionally, the control circuit may determine a modulation depth of the signal strength ratio metric modulated signal and generate the signal strength ratio metric modulated signal at that modulation depth.

At block 620, the control circuit may send the signal strength ratio metric modulated signal to the light source interface to cause the light source to emit a signal strength ratio metric modulated light beam. The light source may emit the signal strength ratio metric modulated light beam in any suitable type of photoelectric smoke detector including, but not limited to, a chambered or chamberless photoelectric smoke detector.

At block 630, the control circuit may receive a reflected light signal from the light sensor via the light sensor interface. The reflected light signal may include a signal indicative of a reflection of the signal strength ratio metric light beam and a signal indicative of a noise light. The noise light may be caused by baffle reflection leakage light, line noise, or any combination thereof.

At block 640, the control circuit may demodulate the reflected light signal to create a demodulated reflected light signal.

At block 650, the control circuit may identify a noise signal in the demodulated reflected light signal. In contrast to the portion of the reflected light signal that corresponds to the reflection of the signal strength ratio metric modulated light beam, the noise or interference light (e.g., the baffle reflection leakage light in a chambered photoelectric smoke detector or the ambient light in a chamberless photoelectric smoke detector) may not be modulated. This unmodulated signal may correspond to the noise signal.

At block 652, the control circuit may subtract the noise signal (from block 680) from the demodulated reflected light signal to isolate a portion of the demodulated reflected light signal corresponding to the reflection of the signal strength ratio metric modulated light beam. Once the noise signal is subtracted, the portion of the demodulated reflected light signal corresponding to the reflection of the signal strength ratio metric modulated light beam may be used to identify the presence of smoke particles in the vicinity of the photoelectric smoke detector without interference from noise, which may reduce the occurrence of false alarms.

At block 654, the control circuit may set an interference level value based on the noise signal identified at block 650. The interference level value may be based on the application in which the photoelectric smoke detector is used. For example, a chambered photoelectric smoke detector may have a lower interference level value than a chamberless photoelectric smoke detector.

At block 660, the control circuit may determine a strength of the reflected light signal. The strength of the reflected light signal may be used an indicator of whether to ignore noise or interference light that does not have a continuous modulation scheme corresponding to the modulation scheme of the signal strength ratio metric modulated light beam. By ignoring the noise or interference light, the noise in the reflected light signal may be reduced.

At block 662, the control circuit may determine a modulation depth of the demodulated reflected light signal. The modulation depth of the demodulated reflected light signal may be the ratio of the peak-to-peak amplitude of the demodulated reflected light signal to the peak-to-peak amplitude of the reflected light signal. The modulation depth may determine the extent to which the reflected light signal is modulated by the modulating signal.

At block 664, the control circuit may compare the modulation depth of the demodulated reflected light signal (from block 660) to a modulation depth of the signal strength ratio metric modulated signal (from block 610) to determine an interference noise.

At block 666, the control circuit may trigger a retest when the interference noise exceeds a threshold. When the control circuit triggers a retest, method 600 may return to block 610 to repeat the test.

At block 668, the control circuit may trigger an alert if a time interval is exceeded. The time interval may be exceeded when the detector has been rendered incapable by too much interfering light for too long. This time interval may be set by local regulations.

At block 670, the control circuit may integrate the demodulated reflected light signal to increase a signal-to-noise ratio of the demodulated reflected light signal. Integrating the demodulated reflected light signal may average the noise signal out over time.

At block 672, the control circuit may determine if an alarm threshold has been exceeded. The alarm threshold may be based on the signal-to-noise ratio of the demodulated reflected light signal after the demodulated reflected light signal is integrated at block 670.

At block 674, the control circuit may trigger an alarm when the threshold is exceeded and an interference level value has not been exceeded. The threshold may be based on local regulations of acceptable obscuration. The interference level value may be the interference level value set at block 654. When the control circuit triggers the alarm, method 600 may return to block 610 to repeat the test. If the interference level value is exceeded, method 600 may end and not trigger a retest.

At block 680, the control circuit may determine a strength of the demodulated reflected light signal. At block 682, the control circuit may determine if the strength of the demodulated reflected light signal (determined at block 680) exceeds an alarm threshold.

At block 684, the control circuit may trigger an alarm when the strength of the demodulated reflected light signal exceeds the threshold and an interference level value (set at block 654) has not been exceeded. The threshold may be based on local regulations of acceptable obscuration. When the control circuit triggers the alarm, method 600 may return to block 610 to repeat the test. If the interference level value is exceeded, method 600 may end and not trigger a retest.

Although FIGS. 6A and 6B disclose a particular number of operations related to method 600, method 600 may be executed with greater or fewer operations than those depicted in FIGS. 6A and 6B. In addition, although FIGS. 6A and 6B discloses a certain order of operations to be taken with respect to method 600, the operations comprising method 600 may be completed in any suitable order.

Although examples have been described above, other variations and examples may be made from this disclosure without departing from the spirit and scope of these disclosed examples.

1. An apparatus, comprising:
a light source interface communicatively coupled to a light source in a photoelectric smoke detector;
a light sensor interface communicatively coupled to a light sensor in the photoelectric smoke detector;
a control circuit communicatively coupled to the light source interface and the light sensor interface, the control circuit to:
generate a signal strength ratio metric modulated signal at a modulation depth;
send the signal strength ratio metric modulated signal to the light source interface to cause the light source to emit a signal strength ratio metric modulated light beam; and
receive a reflected light signal from the light sensor via the light sensor interface, the reflected light signal including a signal indicative of a reflection of the signal strength ratio metric modulated light beam and a signal indicative of a noise light.

2. The apparatus of claim 1, wherein the control circuit is to:
demodulate the reflected light signal to create a demodulated reflected light signal;
determine a strength of the demodulated reflected light signal; and
trigger an alarm when the strength of the demodulated reflected light signal exceeds a threshold.

3. The apparatus of claim 1, wherein the control circuit is to:
demodulate the reflected light signal to create a demodulated reflected light signal;
determine a strength and a modulation depth of the demodulated reflected light signal;
determine a strength of the reflected light signal;
compare the modulation depth of the demodulated reflected light signal to the modulation depth of the signal strength ratio metric modulated signal to determine an interference noise; and
trigger a retest when the interference noise exceeds a threshold.

4. The apparatus of claim 1, wherein the control circuit is to determine a modulation depth of the signal strength ratio metric modulated signal.

5. The apparatus of claim 1, wherein the control circuit is to determine, using spread spectrum modulation, a set of modulation frequencies of the signal strength ratio metric modulated signal.

6. The apparatus of claim 1, wherein the control circuit is to:
demodulate the reflected light signal to create a demodulated reflected light signal;
identify a noise signal in the demodulated reflected light signal; and
subtract the noise signal from the demodulated reflected light signal to isolate a portion of the demodulated reflected light signal corresponding to the reflection of the signal strength ratio metric modulated light beam.

7. The apparatus of claim 1, wherein the control circuit is to:
demodulate the reflected light signal to create a demodulated reflected light signal; and
integrate the demodulated reflected light signal to increase a signal-to-noise ratio of the demodulated reflected light signal.

8. A system, comprising:
a light source;
a light sensor; and
a control circuit to:
generate a signal strength ratio metric modulated signal at a modulation depth;
send the signal strength ratio metric modulated signal to the light source to cause the light source to emit a signal strength ratio metric modulated light beam; and
receive a reflected light signal from the light sensor, the reflected light signal including a signal indicative of a reflection of the signal strength ratio metric modulated light beam and a signal indicative of a noise light.

9. The system of claim 8, wherein the control circuit is to:
demodulate the reflected light signal to create a demodulated reflected light signal;
determine a strength of the demodulated reflected light signal; and
trigger an alarm when the strength of the demodulated reflected light signal exceeds a threshold.

10. The system of claim 8, wherein the control circuit is to:
demodulate the reflected light signal to create a demodulated reflected light signal;
determine a strength and a modulation depth of the demodulated reflected light signal;
determine a strength of the reflected light signal;
compare the modulation depth of the demodulated reflected light signal to the modulation depth of the signal strength ratio metric modulated signal to determine an interference noise; and
trigger a retest when the interference noise exceeds a threshold.

11. The system of claim 8, wherein the control circuit is to determine a modulation depth of the signal strength ratio metric modulated signal.

12. The system of claim 8, wherein the control circuit is to determine, using spread spectrum modulation, a set of modulation frequencies of the signal strength ratio metric modulated signal.

13. The system of claim 8, wherein the control circuit is to:
demodulate the reflected light signal to create a demodulated reflected light signal;
identify a noise signal in the demodulated reflected light signal; and
subtract the noise signal from the demodulated reflected light signal to isolate a portion of the demodulated reflected light signal corresponding to the reflection of the signal strength ratio metric modulated light beam.

14. The system of claim 8, wherein the control circuit is to:
demodulate the reflected light signal to create a demodulated reflected light signal; and
integrate the demodulated reflected light signal to increase a signal-to-noise ratio of the demodulated reflected light signal.

15. A method, comprising:
generating a signal strength ratio metric modulated signal at a modulation depth to cause a light source in a photoelectric smoke detector to emit a signal strength ratio metric modulated light beam; and
receiving a reflected light signal from a light sensor in the photoelectric smoke detector, the reflected light signal including a signal indicative of a reflection of the signal strength ratio metric modulated light beam and a signal indicative of a noise light.

16. The method of claim 15, comprising:
demodulating the reflected light signal to create a demodulated reflected light signal;
determining a strength of the demodulated reflected light signal; and
triggering an alarm when the strength of the demodulated reflected light signal exceeds a threshold.

17. The method of claim 15, comprising:
demodulating the reflected light signal to create a demodulated reflected light signal;
determining a strength and a modulation depth of the demodulated reflected light signal;
determining a strength of the reflected light signal;
comparing the modulation depth of the demodulated reflected light signal to the modulation depth of the signal strength ratio metric modulated signal to determine an interference noise; and
triggering a retest when the interference noise exceeds a threshold.

18. The method of claim 15, comprising determining, using spread spectrum modulation, a set of modulation frequencies of the signal strength ratio metric modulated signal.

19. The method of claim 15, comprising:
demodulating the reflected light signal to create a demodulated reflected light signal;
identifying a noise signal in the demodulated reflected light signal; and
subtracting the noise signal from the demodulated reflected light signal to isolate a portion of the demodulated reflected light signal corresponding to the reflection of the signal strength ratio metric modulated light beam.

20. The method of claim 15, comprising:
demodulating the reflected light signal to create a demodulated reflected light signal; and
integrating the demodulated reflected light signal to increase a signal-to-noise ratio of the demodulated reflected light signal.
